(19) United States
(12) Patent Application Publication
(10) Pub. No.: US 2024/0249095 A1
(43) Pub. Date: Jul. 25, 2024

(54) BARCODE SCANNING WITH AUTOMATIC PICK MODE OPERATION

(71) Applicant: Datalogic IP Tech S.r.l., Lippo di Calderara di Reno (Bologna) (IT)

(72) Inventor: Jaehoon LEE, Seoul (KR)

(21) Appl. No.: 18/420,586

(22) Filed: Jan. 23, 2024

Related U.S. Application Data
(60) Provisional application No. 63/481,171, filed on Jan. 23, 2023.

(51) Int. Cl. G06K 7/14; G06K 7/10

(52) U.S. Cl. CPC G06K 7/1439; G06K 2007/10524

(57) ABSTRACT

The disclosure relates to a barcode reader configured to operate in either a non-pick mode or a pick mode, such that the barcode reader is configured to automatically switch between the non-pick mode and the pick mode in response to detecting the number of barcodes currently present within the field-of-view of the barcode reader.

### RELATED APPLICATIONS

This application claims the benefit of U.S. Provisional Application No. 63/481,171, filed Jan. 23, 2023, and entitled “Barcode Scanning with Automatic Pick Mode Operation,” the disclosure of which is incorporated by reference herein in its entirety.

### TECHNICAL FIELD

The present disclosure relates generally to scanners or code readers, and more particularly, to code readers having the ability to resolve decoding a barcode from among a group of barcodes within a field of view.

### BACKGROUND

End-users of barcode readers occasionally encounter the situation where multiple barcodes exist on an item very close to each other within the reader's field of view, which sometimes results in the barcode reader decoding the incorrect barcode. A conventional method to deal with this situation is to enable a “pick mode” which allows the user to pick out a barcode to decode from a group of barcodes. Pick mode may result in lower readability than non-pick mode. The user may desire to enter pick mode and then exit pick mode, which is typically done via manually initiating a setting (e.g., by scanning a specific barcode for changing a given mode of operation). Time may be wasted going back and forth between pick mode and regular mode (i.e., non-pick mode) as the user is tasked with changing the modes.

### BRIEF SUMMARY

A barcode reader comprises an imager configured to capture an image of a scene according to a field-of-view; and a processor operable coupled to the imager. The processor may be configured operate the barcode reader in one of a pick mode or a non-pick mode, automatically enter the pick mode responsive to detecting multiple barcodes in the image within the field of view of the imager, and automatically enter the non-pick mode responsive to detecting a single barcode in the image within the field of view of the imager.

A method of operating a barcode reader in an automatic pick mode selection process may comprise operating a decoder of the barcode reader in one of a pick mode or a non-pick mode, detecting multiple barcodes within a field-of-view of a barcode scanner and automatically operating a decoder in the pick mode in response thereto, and detecting a single barcode within the field-of-view of a barcode scanner and automatically operating the decoder in the non-pick mode in response thereto.

Another method of operating a barcode reader in an automatic pick mode selection process may comprise automatically switching between operating the barcode reader in a pick mode and a non-pick mode depending on a number of barcodes detected within a field-of-view in real time.

### BRIEF DESCRIPTION OF THE DRAWINGS

FIG. 1 is an example barcode reader that includes a handle that a user may hold and trigger for the user to engage according to embodiments of the disclosure.

FIG. 2 is a flowchart illustrating a method for operating a barcode reader with an automatic pick mode feature according to an embodiment of the disclosure.

FIG. 3 is an example of a label that may include multiple barcodes.

FIG. 4 is an example of a label that may include a single barcode.

### DETAILED DESCRIPTION

The illustrations included herewith are not meant to be actual views of any particular systems, memory device, architecture, or process, but are merely idealized representations that are employed to describe embodiments herein. Elements and features common between figures may retain the same numerical designation except that, for ease of following the description, for the most part, reference numerals begin with the number of the drawing on which the elements are introduced or most fully described. In addition, the elements illustrated in the figures are schematic in nature, and many details regarding the physical layout and construction of a memory array and/or all steps necessary to access data may not be described as they would be understood by those of ordinary skill in the art.

As used herein, the singular forms “a,” “an,” and “the” are intended to include the plural forms as well, unless the context clearly indicates otherwise.

As used herein, “or” includes any and all combinations of one or more of the associated listed items in both, the conjunctive and disjunctive senses. Any intended descriptions of the “exclusive-or” relationship will be specifically called out.

As used herein, the term “configured” refers to a structural arrangement such as size, shape, material composition, physical construction, logical construction (e.g., programming, operational parameter setting) or other operative arrangement of at least one structure and at least one apparatus facilitating the operation thereof in a defined way (e.g., to carry out a specific function or set of functions).

As used herein, the phrases “coupled to” or “coupled with” refer to structures operably connected with each other, such as connected through a direct connection or through an indirect connection (e.g., via another structure or component).

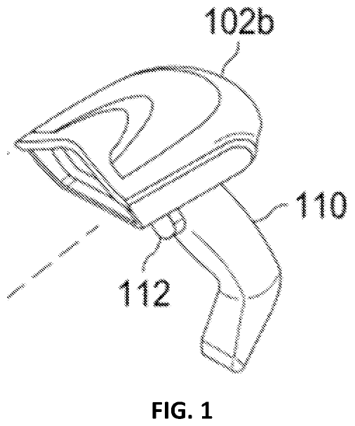

FIG. 1 is an example barcode reader 102b that includes a handle 110 that a user may hold and trigger 112 for the user to engage according to embodiments of the disclosure. The barcode reader 102b may include a processor in operable communication with one or more imagers for capturing images of a scene and decoding machine-readable indicia on an item in its field of view (i.e., a code read). The barcode reader 102b may also include illumination sources (e.g., LEDs) that provide illumination to improve scan performance, and in some embodiments an aiming light source may be provided to assist the user in aiming the barcode reader 102b so that the item is more fully within the field of view of the imager.

Embodiments of the disclosure related to barcode readers having different configuration and form factors, including handheld scanners, mobile computers, presentation scanners, fixed scanners, wearable scanners (e.g., worn on wrist, hand, glasses, etc.), and other arrangements and configurations. For example, additional features and configurations of devices are described in the following patents and patent applications: U.S. Pat. No. 9,087,251, issued Jul. 21, 2015, and entitled “DATA READER WITH MULTIPLE MODES OF OPERATION,” U.S. Pat. No. 10,025,966, issued Jul. 17, 2018, and entitled “CODED IMAGE CAPTURE SYSTEM OF COMPONENTS,” U.S. Pat. No. 10,146,975, issued Dec. 4, 2018, and entitled “DATA READER WITH HYBRID AUTO FOCUS SYSTEM,” the disclosure of each of which is incorporated by reference in their entirety.

The user may cause the barcode reader 102b to scan or image the machine-readable indicia by pressing a trigger button to initiate a code read. In some embodiments, the barcode reader 102b may be configured to be in presentation mode and continuously capture images and decode the machine-readable indicia without pressing a trigger button. The processor may implement a decoder that generates a decoded output from analyzing the image with the machine-readable indicia.

Embodiments of the disclosure include the barcode reader 102b being configured to operate with an automatic pick mode configuration setting. The barcode reader 102b may be configured to detect the presence of multiple barcodes on an object within the field-of-view of its imager and automatically enter a pick mode. In the pick mode, the user may use the aimer to select which barcode of the plurality should be decoded by the processor. In some embodiments, the pick mode may define a hierarchy of barcodes which should be decoded (e.g., decode 2D code if present, then 1D code, etc.). In some embodiments, the barcode reader may exit the pick mode after the successful decoding while searching for the next barcode and/or if only a single barcode is detected within the field-of-view. Transitioning between pick mode and non-pick mode may be automatic as opposed to requiring user input to enable a smooth operation that may improve the performance of the barcode reader and improve user speed. For example, the bar code reader may transition from regular mode (i.e., non-pick mode) to pick mode automatically without user input responsive to the processor detecting multiple bar codes in the captured image. The bar code reader may transition from pick mode to regular mode automatically without user input responsive to the processor detecting an exit mode event. In some embodiments, the exit mode event may include the barcode being decoded. In some embodiments, the exit mode event may include the processor detecting the item with the multiple barcodes exiting the field of view of the bar code reader. The code reader may then remain in the regular mode until a new item is detected with multiple bar codes present in the field of view. In some embodiments, the barcode reader may remain in the regular mode even after the barcode is decoded or the item exits the field of view until the processor detecting only one barcode, after which the transition to regular mode may occur.

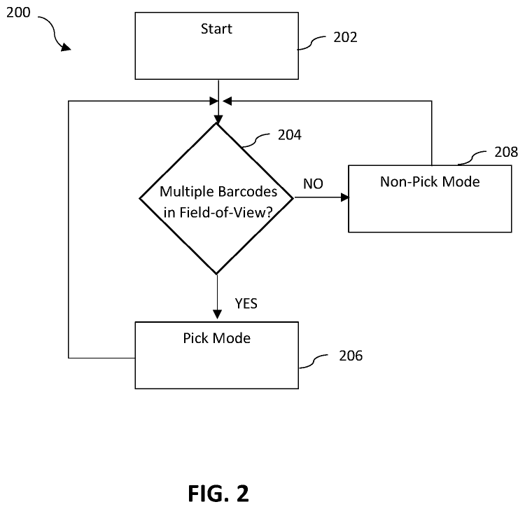

FIG. 2 is a flowchart illustrating a method 200 for operating a barcode reader with an automatic pick mode feature according to an embodiment of the disclosure. At operation 202, the automatic pick mode selection process may start (e.g., via power up, an initial user selection to enable this automatic operation, etc.). Initially entering the automatic pick mode selection process may be selected by user input. In other words, the user may enable or disable this automatic pick mode selection process if desired. In some embodiments, initially entering the automatic pick mode selection process may be selected during power up by default. This entire selection process may be enabled or disabled as desired (including by user input), but once operating according to the automatic pick mode selection process, transitioning between pick mode and non-pick mode may occur automatically in real time without user input as described herein.

In some embodiments, the barcode reader may be operating in regular mode (e.g., non-pick mode). During this time, one or more images may be captured by one or more of the imagers of the barcode reader, which may then be communicated to the processor. In some embodiments, images may be captured responsive to a trigger event (e.g., manual trigger press, continuous image capturing of a presentation scanning session, object sense trigger, etc.).

At operation 204, the barcode reader may determine whether more than one barcode is present within its field of view. For example, the processor may initiate an initial evaluation of the image to recognize barcode(s) presence before performing the decoding analysis.

If multiple barcodes are determined to be present, the barcode reader may automatically (i.e., without additional user input) enter pick mode at operation 206. During pick mode, the operations of pick mode are enabled. For example, the user may point an aimer at the barcode that is desired to be decoded while the decoder ignores other barcodes within the field of view. If the barcode reader does not detect multiple barcodes within the field of view (e.g., only a single barcode is present, or no barcodes are present), the barcode reader may automatically (i.e., without additional user input) enter non-pick mode at operation 208, during which the operations of pick mode are disabled. For example, the barcode reader may analyze the entire scene for the decoding algorithm to detect and decode a barcode located therein.

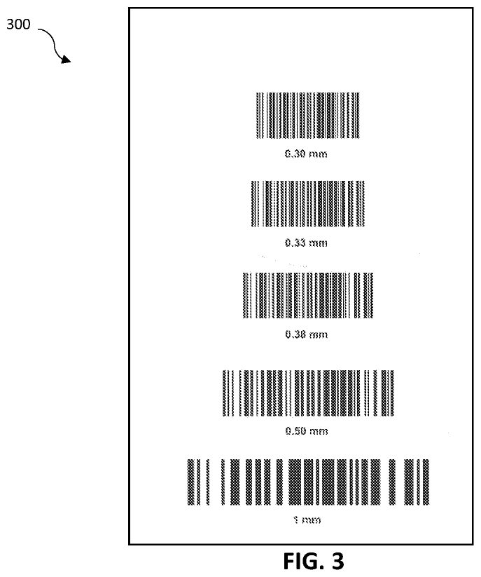

FIG. 3 is an example of a label that may include multiple barcodes. In this example, the barcode reader is configured to detect the presence of the multiple barcodes and automatically enter pick mode (or remain in pick mode depending on the present state). The processor of the barcode reader may decode one of the barcodes according the decoding operations of the pick mode. In some embodiments, the multiple barcodes detected may be of the same barcode type (e.g., multiple 1D barcodes, multiple 2D barcodes, etc.). In some embodiments, the multiple barcodes detected may be of different barcode types (e.g., a 1D barcode (or different types of 1D barcodes), a 2D barcode (or different types of 2D barcodes), etc.) Any combination of different types of barcodes is contemplated as embodiments of the disclosure.

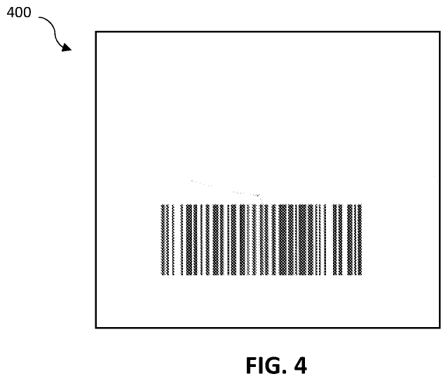

FIG. 4 is an example of a label that may include a single barcode. In this example, the barcode reader is configured to detect the presence of the single barcodes and automatically enter non-pick mode (or remain in non-pick mode depending on the present state). The processor of the barcode reader may decode the barcode according to its normal decoding operations. Transitioning between pick mode or non-pick mode may occur based on the detection of multiple barcodes being present automatically by the barcode reader without user operations such as a manual input to the device, scanning a special barcode, etc. Doing so may improve user ease of use and increase the devices speed of operation.

The foregoing method descriptions and/or any process flow diagrams are provided merely as illustrative examples and are not intended to require or imply that the steps of the various embodiments must be performed in the order presented. As will be appreciated by one of skill in the art, the steps in the foregoing embodiments may be performed in any order. Words such as “then,” “next,” etc. are not intended to limit the order of the steps; these words are simply used to guide the reader through the description of the methods. Although process flow diagrams may describe the operations as a sequential process, many of the operations may be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

The various illustrative logical blocks, modules, circuits, and algorithm steps described in connection with the embodiments disclosed here may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to and/or in communication with another code segment or a hardware circuit by passing and/or receiving information, data, arguments, parameters, or memory contents. Information, arguments, parameters, data, etc. may be communicated (e.g., passed, forwarded, and/or transmitted) via any suitable means including memory sharing, message passing, token passing, network transmission, etc.

The actual software code or specialized control hardware used to implement these systems and methods is not limiting of the disclosure. Thus, the operation and behavior of the systems and methods were described without reference to the specific software code being understood that software and control hardware can be designed to implement the systems and methods based on the description here.

When implemented in software, the functions may be stored as one or more instructions or code on a non-transitory computer-readable or processor-readable storage medium. The steps of a method or algorithm disclosed here may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used here, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The previous description is of various preferred embodiments for implementing the disclosure, and the scope of the invention should not necessarily be limited by this description. The scope of the present invention is instead defined by the claims.

What is claimed:

1. A barcode reader, comprising:
an imager configured to capture an image of a scene according to a field-of-view;
a processor operably coupled to the imager, the processor configured to:
operate the barcode reader in one of a pick mode or a non-pick mode;
automatically enter the pick mode responsive to detecting multiple barcodes in the image within the field-of-view of the imager; and
automatically enter the non-pick mode responsive to detecting a single barcode in the image within the field-of-view of the imager.

2. The barcode reader of claim 1, wherein the processor remains in the non-pick mode after decoding the single barcode when no barcodes are detected to be present.

3. The barcode reader of claim 1, wherein the processor enters the non-pick mode after decoding a selected barcode while in the pick mode when no new barcodes are detected to be present.

4. The barcode reader of claim 1, further comprising a housing configured in a handheld configuration.

5. The barcode reader of claim 1, further comprising a housing configured in a presentation configuration.

6. The barcode reader of claim 1, wherein the barcode reader is a mobile computer.

7. The barcode reader of claim 1, wherein the multiple barcodes are of a same barcode type.

8. The barcode reader of claim 1, wherein the multiple barcodes are of a different barcode type.

9. The barcode reader of claim 8, wherein one barcode type is a 1D barcode, and another barcode type is a 2D barcode.

10. The barcode reader of claim 8, wherein one barcode type is a first type of 1D barcode, and another barcode type is a second type of 1D barcode detected by the processor from the image.

11. The barcode reader of claim 8, wherein one barcode type is a first type of 2D barcode, and another barcode type is a second type of 2D barcode detected by the processor from the image.

12. A method of operating a barcode reader in an automatic pick mode selection process, the method comprising:
operating a decoder of the barcode reader in one of a pick mode or a non-pick mode;
detecting multiple barcodes within a field-of-view of a barcode scanner and automatically operating a decoder in the pick mode in response thereto; and
detecting a single barcode within the field-of-view of a barcode scanner and automatically operating the decoder in the non-pick mode in response thereto.

13. The method of claim 12, further comprising detecting no barcodes within the field-of-view and operating the decoder on the non-pick mode in response thereto.

14. The method of claim 12, wherein initially entering the automatic pick mode selection process is selected by user input.

15. The method of claim 12, wherein initially entering the automatic pick mode selection process is selected during power up by default.

16. A method of operating a barcode reader in an automatic pick mode selection process, the method comprising automatically switching between operating the barcode reader in a pick mode and a non-pick mode depending on a number of barcodes detected within a field-of-view in real time.

17. The method of claim 16, wherein automatically switching between the pick mode and the non-pick mode includes transitioning from the non-pick mode to the pick mode responsive to a processor of the barcode reader detecting multiple barcodes from a captured image in real time while operating in the non-pick mode.

18. The method of claim 16, further comprising transitioning from the pick mode to the non-pick mode responsive to an exit mode event.

19. The method of claim 16, wherein automatically switching between the pick mode and the non-pick mode includes transitioning from the pick mode to the non-pick mode responsive to a processor of the barcode reader detecting a single barcode from a captured image in real time while operating in the pick mode.

20. The method of claim 18, wherein the exit mode event includes at least one of detecting an item with the multiple barcodes exiting the field-of-view of the bar code reader, detecting only one barcode within the field-of-view, or decoding a selected barcode while within the pick mode.
